(19) United States
(12) Patent Application Publication
(10) Pub. No.: US 2013/0189386 A1
(43) Pub. Date: Jul. 25, 2013

(54) NON-RETURN VALVE FOR CALIBRATION TANKS

(71) Applicant: Meinhard Schwaiger, Linz (AT)

(72) Inventor: Meinhard Schwaiger, Linz (AT)

(73) Assignee: AMX AUTOMATION TECHNOLOGIES GMBH, Linz (AT)

(21) Appl. No.: 13/811,396

(22) PCT Filed: Jun. 29, 2011
(86) PCT No.: PCT/EP2011/060922

§ 371 Date: Mar. 14, 2013

(30) Foreign Application Priority Data
Jul. 22, 2010 (AT) A 1230/2010

(51) Int. Cl. B29C 47/88

(52) U.S. Cl. CPC B29C 47/8815
USPC 425/71

(57) ABSTRACT

A non-return valve for calibration tanks for energy-saving calibration and cooling of plastic profiles which are continuously produced by an extrusion method. A cooling medium is aspirated from a calibration tank via a suction opening and a flow turbine with which the cooling medium and aspirated air are swirled.

### CROSS-REFERENCE TO RELATED APPLICATIONS

The present application is a National Stage Application of PCT International Application No. PCT/EP2011/060922 (filed on Jun. 29, 2011), under 35 U.S.C. §371, which claims priority to Austrian Patent Application No. A1230/2010 (filed on Jul. 22, 2010), which are each hereby incorporated by reference in their respective entireties.

### TECHNICAL FIELD

The present invention relates to a non-return valve for calibration tanks for energy-saving calibration and cooling of plastic profiles which are continuously produced by the extrusion method.

Calibration tools for plastic profiles are used for the defined cooling and shaping of the profile strand formed in an extrusion die and comprise at least one dry calibration tool and at least one calibration tank which can also be placed under vacuum and comprises several so-called calibration screens. The defined heat dissipation from the profile strand occurs in the dry calibre by means of heat transmission from the profile surface to the inside surface of the dry calibration tool which is cooled with cooling water, and in the calibration tank the heat dissipation from the profile strand occurs directly into the cooling medium (which is usually cooling water) which flows around the profile strand. In the dry calibration tool, the still soft profile strand will be sucked by means of vacuum against the inside surface of the dry calibration tool, with the inside surface being provided with the negative contour of the profile geometry, by ensuring the most complete contact of the profile contour with the negative contour in order to ensure the best possible and constant heat transfer from the profile surface to the inside surface of the dry calibre. The profile strand will be guided in supporting screens in the calibration tank and the cooling medium flows through the calibration tank in the longitudinal direction and removes the residual thermal energy introduced in the upstream extruder, and changes in the shape caused by shrinkage processes by cooling in the profile will be counteracted by means of a defined vacuum in the calibration tank.

### BACKGROUND OF THE INVENTION

Calibration systems correspond to the state of the art, which systems consist of one or several dry calibres followed by one or several calibration tanks These calibration tanks consist of a vacuum-proof tank, several supporting screens adjusted to the shape of the profile and terminal screens enclosing the profile at the two end sides.

A cooling medium will be supplied at one or several points in the calibration tank and sucked off by means of vacuum preferably at one (or several) point(s) arranged in an offset manner in the longitudinal direction. The cooling medium will be subjected to turbulences arranged more or less strongly by means of purposeful guidance of the flow for the purpose of increasing the cooling effect.

In another embodiment, the cooling medium will be sprayed by a plurality of spray nozzles in a fine mist onto the surface of the profile strand and will flow freely from the profile stand down onto the base of the calibration tank and will be removed there from the calibration tank via a mostly central suction line by means of vacuum. In all such systems, there is a more or less high water level in the region of the suction opening and both air and water are removed simultaneously, leading to partly unmanageable pressure situations because the relative water/air quantities are subjected to continuous fluctuations.

In the case of a low fraction of air, a higher flow resistance is produced in the suction line and the negative pressure of the suction line does not reach up the calibration tank, whereas in the case of a higher air fraction the flow resistance in the suction line will decrease suddenly and the negative pressure from the suction line will reach up into the calibration tank. These cases lead to enormous pressure fluctuations which render high-quality calibration impossible. The only measure to avoid this problem currently is a supply of ambient air into the calibration tank that is subjected to vacuum. A superimposed air flow will be generated in this process, which produces a “buffer effect” and is capable of substantially compensating pressure fluctuations in the vacuum.

It will be disadvantageous, however, that as a result of the supply of an air flow from the ambient air into the vacuum system a substantially higher demand for power will occur for maintaining the vacuum level.

An apparatus is known from EP 1 525 083 which produces a water level control in the calibration tank, so that only water will be removed via the suction line and thereby uncontrolled pressure fluctuations can be avoided without the need of having to supply fresh air. The enormous need for apparatuses and control technology has a disadvantageous effect, which virtually prevents economical implementation.

### SUMMARY OF THE INVENTION

It is the object of the present invention to achieve a constant vacuum level within the calibration tanks, even in the case of a strongly fluctuating water level, without having to apply highly complex apparatuses and control measures and without the supply of ambient air in order to simultaneously achieve the lowest possible need for energy for removing the cooling medium from the calibration tank and for vacuum calibration.

In accordance with the invention, the object of achieving a negative pressure which is constant within the calibration tank and is simple to adjust in combination with lowest possible input of energy is achieved in such a way that an intensive swirling of the outgoing cooling water with the removed air fraction is produced in the suction opening.

The effect is that a kind of “air-water colloid” is produced which fills the entire cross-section of the suction line over a specific length in the suction region from the calibration tank and prevents that the negative pressure from the suction system will penetrate the calibration tank and cause pressure fluctuations. A kind of “dynamic non-return valve” is produced in this manner. The swirling can be produced in the simplest possible way by a small flow turbine which is integrated in the suction line and which is made to rotate by the air flow. It is possible in this simple way to produce a highly stable vacuum level in the calibration tanks, which also occurs when the water level in the suction chamber is highly fluctuating and the fraction of the water cross-section and the air cross-section in the suction opening varies strongly in a continuous manner.

### BRIEF DESCRIPTION OF THE DRAWINGS

The present invention will be explained below in closer detail by reference to the embodiment shown in the drawing, wherein:

FIG. 1 illustrates a perspective view of a calibration tank with a swirling turbine in accordance with the invention.

FIG. 2 illustrates the calibration tank of FIG. 1 from the face side.

FIG. 3 illustrates a longitudinal sectional view (side view) of the calibration tank of FIG. 2 along the line of intersection B-B.

FIG. 4 illustrates a longitudinal sectional view (top view) of the calibration tank of FIG. 2 along the line of intersection A-A.

FIG. 5 illustrates a detailed view of the calibration tank of FIG. 3.

### DETAILED DESCRIPTION OF EMBODIMENTS

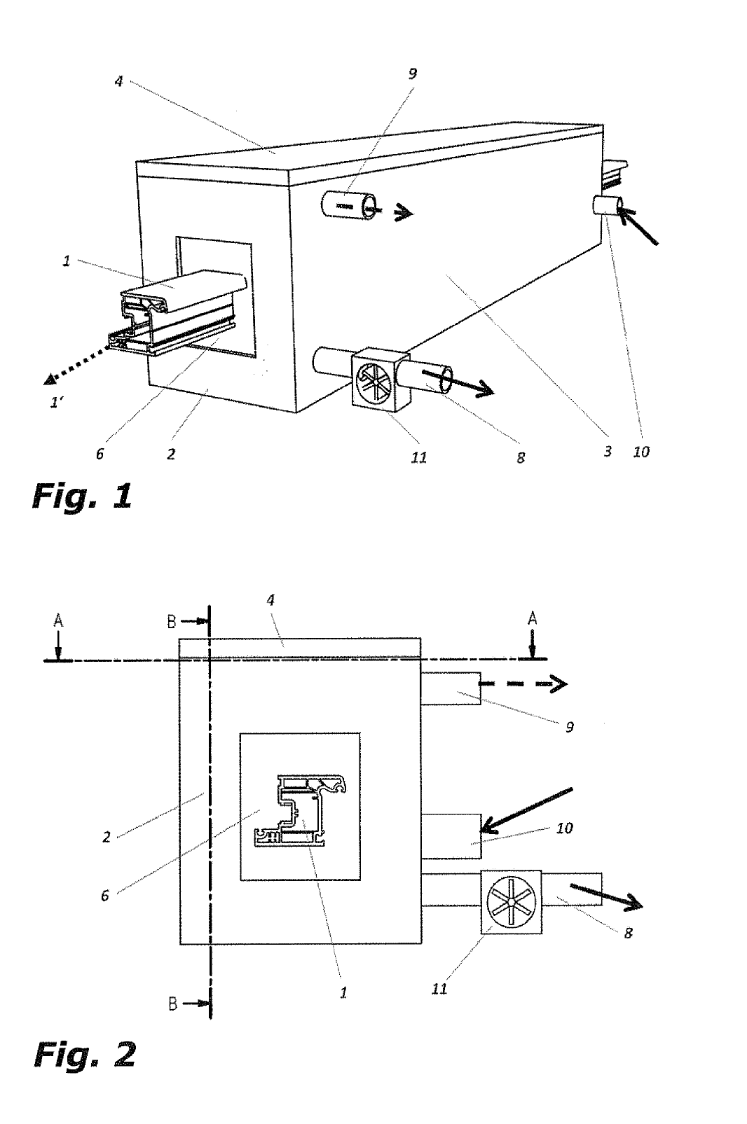

The invention will be explained in closer detail by reference to FIGS. 1 to 5.

FIG. 1 illustrates in a perspective view a calibration tank having front sides 2, lateral sides 3, and a cover 4, with a swirling turbine 11 in accordance with the invention. The profile strand 1, which is produced in a continuous manner by extrusion, will be conveyed in the extrusion direction 1′ through the calibration tank. The profile strand 1 is guided through the openings adjusted to the shape of the profile in the tank screens and the terminal screens 6 which are disposed on the two front sides 2 and which seal the calibration tank to the outside. In the closed state, the cooling medium will be conveyed via the feed opening 10 into the calibration tank and discharged via the suction opening 8. A negative pressure is produced in the interior of the calibration tank via the air suction opening 9. Aspirated cooling medium will be swirled in the flow turbine 11 with the entrained air.

FIG. 2 illustrates the calibration tank from the face side. The tank cover 4 is closed in the production state.

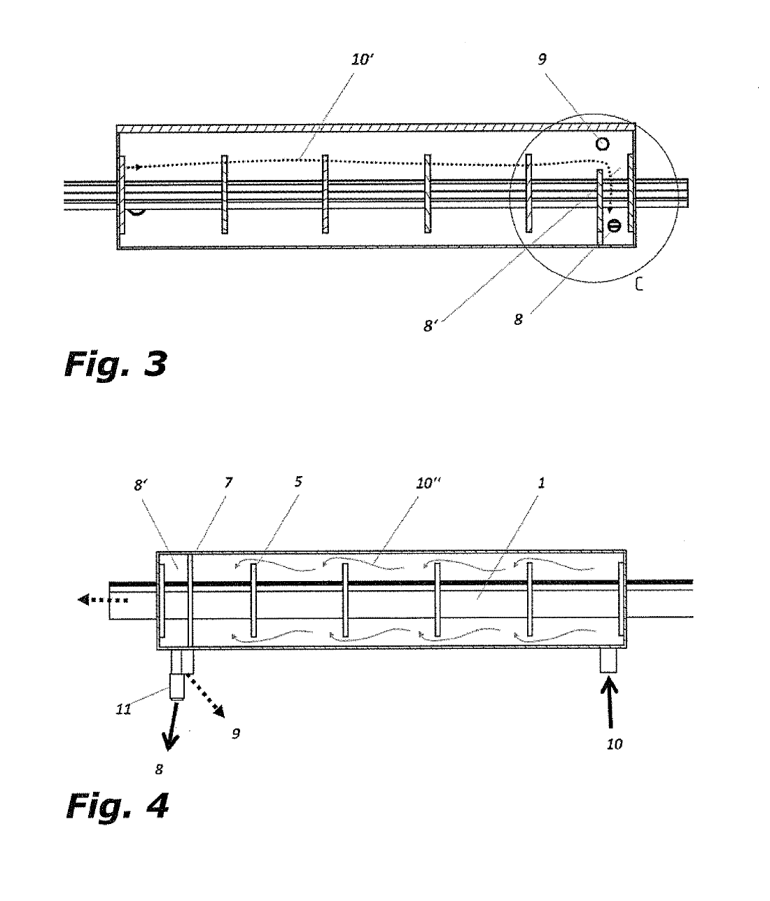

FIG. 3 illustrates a longitudinal sectional view (side view) of the calibration tank along the line of intersection B-B according to FIG. 2. The illustration illustrates the cooling medium supply 10, the cooling medium flow 10′ above the profile strand 1 and the overflow of the cooling medium flow into the suction chamber 8′ and the suction opening 8. The negative pressure within the vibration tank will be generated by means of the air suction opening 9.

FIG. 4 illustrates a longitudinal sectional view (top view) of the calibration tank along the line of intersection A-A according to FIG. 2. The tank screens 5 guide the profile 1 and the cooling medium flows about the profile 1 in the direction of flow. The cooling medium can flow about the tank screens along the flow FIGS. 10″. The cooling medium is aspirated via the suction opening 8 from the suction chamber 8′.

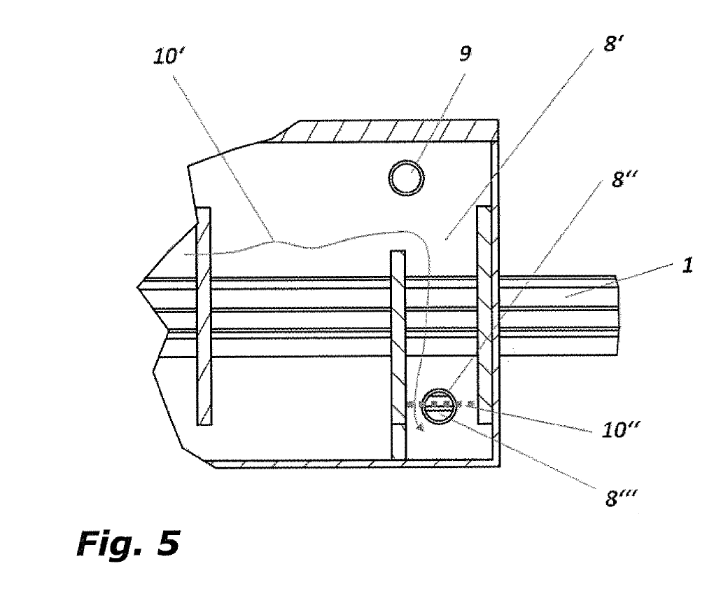

FIG. 5 illustrates a detailed view (C) of FIG. 3. The cooling medium 10′ flows into the suction chamber 8′ and forms a varying level relative to the suction opening 8. The cross-sectional fraction 8″ corresponds to the air cross section and the cross-sectional fraction 8′″ corresponds to the water fraction in the suction opening. Aspirated cooling medium and aspirated air will be swirled in the flow turbine to such an extent that an “air-water colloid” is produced and the entire cross-section of the suction opening 8 will be filled with the same, so that the negative pressure of the suction system (not illustrated in closer detail) will not be able to penetrate into the calibration tank.

1-9. (canceled)

10. An apparatus for calibrating and cooling extruded profile strands, the apparatus comprising:
a calibration tank through which the profile stand is guided;
a first suction opening in communication with the calibration tank;
a cooling medium which flows through the calibration tank and around the profile strand, and is aspirated from the calibration tank via the first suction opening; and
a flow turbine in communication with the first suction opening to create turbulent flow of the cooling medium as the cooling medium flows through the calibration tank.

11. The apparatus of claim 10, further comprising a second suction opening in communication with the calibration tank and which is configured to generate negative pressure in the calibration tank.

12. The apparatus of the claim 11, wherein the calibration has a suction chamber through which the cooling medium flows.

13. The apparatus of claim 12, wherein the cooling medium has a fluctuating level in a region of the suction opening.

14. The apparatus of claim 13, wherein the flow turbine comprises an impeller turbine.

15. The apparatus of claim 13, wherein the flow turbine comprises a screw turbine.

16. The apparatus of claim 13, wherein the flow turbine comprises a device having rotatable turbine elements.

17. The apparatus of claim 13, wherein the flow turbine includes rigid flow guide devices.

18. The apparatus of claim 17, wherein the cooling medium is aspirated separately via the first suction opening from the air and the air is aspirated separated from the cooling medium via the second suction opening.

19. The apparatus of claim 17, wherein the cooling medium and the air are aspirated together from the calibration tank.

20. The apparatus of claim 18, wherein the calibration tank comprises a spraying tank.

21. An apparatus for calibrating and cooling extruded profile strands, the apparatus comprising:
a calibration tank through which the profile stand is guided, the calibration tank defining a suction chamber through which air and a fluid medium flows, the fluid medium configured to cool the profile strand as it is guided through the calibration tank;
a first suction opening in communication with the suction chamber and through which the fluid medium is aspirated from the calibration tank;
a second suction opening in communication with the suction chamber and which is configured to generate negative pressure in the calibration tank; and
a device in communication with the suction chamber to create turbulent flow of the fluid medium as the fluid medium flows through the suction chamber.

22. The apparatus of claim 21, wherein the fluid medium has a fluctuating level in a region of the first suction opening.

23. The apparatus of claim 21, wherein the device comprises an impeller turbine.

24. The apparatus of claim 21, wherein the device comprises a screw turbine.

25. The apparatus of claim 21, wherein the device comprises a device having rotatable turbine elements.

26. The apparatus of claim 21, wherein the device includes rigid flow guide devices.

27. The apparatus of claim 21, wherein the fluid medium is aspirated separately via the first suction opening from the air and the air is aspirated separated from the cooling medium via the second suction opening.

28. The apparatus of claim 21, wherein the fluid medium and the air are aspirated together from the calibration tank.

29. The apparatus of claim 21, wherein the calibration tank comprises a spraying tank.
